SEQUENCE LISTING (3 sequences)

SEQ ID NO: 1 - DNA, 27 bp, Artificial Sequence
  Synthetic
tgtggtcccaatgaggtcgatagttta

SEQ ID NO: 2 - DNA, 15 bp, Artificial Sequence
  Synthetic
atgaggtggtagttt

SEQ ID NO: 3 - DNA, 19 bp, Artificial Sequence
  Synthetic
tgtggtcccaatgagttta

(19) United States
(12) Patent Application Publication
(10) Pub. No.: US 2018/0157787 A1
(43) Pub. Date: Jun. 7, 2018

(54) CODING GENOME RECONSTRUCTION FROM TRANSCRIPT SEQUENCES

(71) Applicant: Pacific Biosciences of California, Inc., Menlo Park, CA (US)

(72) Inventor: Huei-Hun Tseng, San Francisco, CA (US)

(21) Appl. No.: 15/785,768

(22) Filed: Oct. 17, 2017

Related U.S. Application Data
(60) Provisional application No. 62/410,244, filed on Oct. 19, 2016.

(51) Int. Cl. G06F 19/18; C40B 40/06; G06F 17/30

(52) U.S. Cl. CPC G06F 19/18; G06F 17/30598; C40B 40/06

(57) ABSTRACT

Exemplary embodiments provide systems, methods and computer program products for generating reconstructed coding genome contigs from full-length transcript sequences without the use of a reference genome. Aspects of an exemplary embodiment include receiving a set of full-length transcript sequences; partitioning the full-length transcript sequences into at least one gene family based on sequence similarity; reconstructing a coding genome contig for each of the at least one gene family without using a reference genome; and outputting the reconstructed coding genome contig for each of the at least one gene family to a user.

### CROSS-REFERENCE TO RELATED APPLICATION

This application claims the benefit of priority to U.S. Provisional Patent Application 62/410,244, filed Oct. 19, 2016, which is hereby incorporated by reference herein in its entirety.

### INCORPORATION-BY-REFERENCE OF MATERIAL SUBMITTED BY U.S.P.T.O. eFS-WEB

The instant application contains a Sequence Listing which is being submitted in computer readable form via the United States Patent and Trademark Office eFS-WEB system and which is hereby incorporated by reference in its entirety for all purposes. The txt file submitted herewith contains a 1 KB file (01020401_2017-12-14_SequenceListing.txt).

### BACKGROUND OF THE INVENTION

Genome assembly is computationally costly and challenging. While the advent of high-throughput sequencing technology has significantly reduced sequencing cost, assembling the genomes of novel species in a de novo manner is still reserved for large consortiums with ample resources. Even with collective efforts such as the Genome 10K Project to sequence more genomes, many species important to biological studies will continue to lack a quality reference genome. Furthermore, many important animal and plant genomes exhibit a high degree of complexity both on a per-species and a per-individual level. For example, salamander species are estimated to have a genome ranging from 14-120 GB with highly repetitive regions due to increased proliferation of LTR retrotransposons (Sun et al. 2012) while the maize (Zea mays) genome has significant structural variation and copy number variation between individuals, many of which harbor coding genes (Swanson-Wagner et al. 2010). All of the above factors contribute to the unlikelihood of prevalent genome sequencing for many species.

In contrast to the behemoth that is genome assembly, transcriptome sequencing is usually affordable and directly relevant to a biological question. Sanger sequencing was able to produce full-length cDNA sequences but were costly and low yielding. High-throughput sequencing technology such as Illumina produce millions of short reads that are a few hundred bases long, which can be used to map back to a reference genome or assembled in a de novo manner (Grabherr et al. 2011). The RNA-seq approach of using fragmented short reads however, poses significant computational challenges and falls short of being able to accurately and unambiguously resolve to full-length transcript isoforms (Steijger et al. 2013; Angelini, Canditiis, and Feis 2014; Chang, Wang, and Li 2014). As such, short reads are only well-suited for gene expression quantification and simple transcript reconstruction.

As long read sequencing technology has made headway into resolving structural repeats and closing assembly gaps in genomes (e.g., long reads obtained using Pacific Biosciences's SMRT® Sequencing technology), it is now being used to generate full-length, single-molecule cDNAs sequences. Using a long read sequencing approach like SMRT® sequencing, one can construct full-length cDNA libraries and obtain full-length cDNA sequences without further fragmentation. Indeed, the PACBIO® ISO-SEQ® method has been applied for whole genome annotation (Gordon et al. 2015; Thomas et al. 2014; Minoche et al. 2015), novel gene and isoform discovery (Pretto et al. 2014; Au and Sebastiano 2014), and cancer fusion gene discovery (Weirather et al. 2015). Several of these studies were carried out in a de novo manner by using the ToFU pipeline (Gordon et al. 2015) developed at PacBio to obtain an unbiased view of the transcriptome. The ToFU pipeline outputs unassembled, full-length, high-quality transcript isoform sequences without using a reference genome, which makes it well-suited for cases in which the reference genome is lacking or of poor quality, as well as in targeted cases where per-individual differences are high, e.g., the MHC region in primates.

The present disclosure provides, inter alia, additional systems, methods, and computer program products for gene family partitioning and subsequent coding genome reconstruction using full-length transcript isoform sequence data without using underlying reference genomic sequence data.

### BRIEF SUMMARY OF THE INVENTION

The exemplary embodiments are generally directed to systems, methods and computer program products for generating reconstructed coding genome contigs from full-length transcript sequences without the use of a reference genome.

Aspects of the present disclosure are drawn to methods of generating a reconstructed coding genome contig for a gene family (or for each of multiple gene families) from a set of full-length transcript sequences, the method performed by at least one software component executing on at least one processor, comprising: receiving a set of full-length transcript sequences; partitioning the full-length transcript sequences into at least one gene family based on k-mer similarity; reconstructing a coding genome contig for each of the at least one gene family without using a reference genome; and outputting the reconstructed coding genome contig for each of the at least one gene family to a user.

In certain embodiments, the partitioning comprises: constructing an undirected weighted graph of the set of full-length transcript sequences comprising nodes and connecting edges, wherein each node in the graph represents a transcript sequence and a connecting edge between two nodes has a weight that is proportional to the number of shared unique k-mers between the two connected nodes, and partitioning the full-length transcript sequences are into at least one gene family based on the constructed graph.

In certain embodiments, constructing the undirected weighted graph comprises employing a locality-sensitive hashing procedure to identify sequence similarities.

In certain embodiments, the locality-sensitive hashing procedure (i) uses a default sketch size of about 1000 and a k-mer size of about 16, and (ii) approximates sequence similarity based on the percentage of matching k-mer sketches.

In certain embodiments, partitioning the nodes into at least one gene family based on the constructed graph comprises identifying connected nodes in the graph and then apply a normalized cut technique.

In certain embodiments, the reconstructing step comprises: building a directed weighted graph for the full-length transcripts of each of the at least one gene family; and simplifying each directed weighted graph to generate a reconstructed coding genome contig for each of the at least one gene family, wherein simplifying comprises: unipath reduction, resolving simple bubbles, or both.

In certain embodiments, the simplifying step comprises unipath reduction.

In certain embodiments, a unipath comprises a continuous path of nodes comprising a leading node having a single outgoing edge, an ending node having a single incoming edge, and one or more intervening nodes each having exactly one incoming edge and one outgoing edge, wherein unipath reduction comprises deleting the one or more intervening nodes.

In certain embodiments, the simplifying step comprises resolving simple bubbles.

In certain embodiments, when the simple bubbles are caused by sequencing errors or a true SNP, the simple bubbles are resolved by merging the nodes in the simple bubble.

In certain embodiments, when the simple bubbles are caused by exon skipping or intron retention, the simple bubbles are resolved by removing the node having the shorter sequence and retaining the node having the longer sequence.

In certain embodiments, the simplifying step is performed multiple times.

In certain embodiments, the directed graph is reduced to one node that represents the reconstructed coding genome contig.

In certain embodiments, the full-length transcript sequences are produced by a single molecule long read sequencing process.

In certain embodiments, the k-mer size is set from about 10 to 30 bases.

In certain embodiments, the sequences have an accuracy of ≥99%.

In certain embodiments, when a partitioned gene family of the at least one gene families is above a threshold size, the method further comprises: (i) splitting the partitioned gene family into multiple sub-partitions; (ii) subjecting each sub-partition to the reconstructing step; (iii) combining the reconstructed coding genome contig for all sub-partitions to generate a combined contig; and (iv) subjecting the combined contig to the reconstructing step.

In certain embodiments, when the reconstructed coding genome contig cannot be resolved unambiguously and thus comprises two or more unconnected contigs, the minimal set of contigs that can fully explain the isoforms is output.

In certain embodiments, the output comprises and displaying visualizations of each of the transcripts of the at least one gene family aligned and the reconstructed coding genome contig.

Aspects of the present disclosure include an executable software product stored on a computer-readable medium containing program instructions for generating a reconstructed coding genome contig for a gene family from a set of full-length transcript sequences according to the method of any one of the methods described above.

Aspects of the present disclosure include a system for generating a reconstructed coding genome contig for a gene family from a set of full-length transcript sequences, comprising: a memory; an input/output module; and a processor coupled to the memory configured to: (i) receive a set of full-length transcript sequences; (ii) partition the nodes into at least one gene family; and (iii) reconstructing a coding genome contig for each of the at least one gene family without using a reference genome; wherein the input/output module is configured to output the reconstructed coding genome contig for each of the at least one gene family to a user.

In certain embodiments, the system further comprises a data repository comprising one or more of: full-length transcript sequences, undirected weighted graphs, directed weighted graphs, partitioned gene families, reconstructed coding genome contig assemblies, and any combination thereof.

In certain embodiments, the processor is configured to perform the method of any one of the methods described above.

In certain embodiments, the system further comprises the executable software product described above.

The invention and various specific aspects and embodiments will be better understood with reference to the following detailed descriptions and figures, in which the invention is described in terms of various specific aspects and embodiments. These are provided for purposes of clarity and should not be taken to limit the invention. The invention and aspects thereof may have applications to a variety of types of systems, methods, devices, and computer program products not specifically disclosed herein.

### BRIEF DESCRIPTION OF SEVERAL VIEWS OF THE DRAWINGS

FIG. 1. Schematic of an exemplary system of the present disclosure.

FIG. 2. Workflow for Cogent (COding GENome reconstruction Tool). Given a set of full-length transcript sequences (top panel), Cogent first partitions the sequences into gene families (middle panel) and then reconstructs the transcribed regions for each gene (bottom panel). For gene A and B, perfect reconstruction (1 contig) is possible; for gene C, there is insufficient information to resolve the extended ends, resulting in two separate contigs.

FIG. 3. Flow chart of an exemplary method for reconstructing a coding genome contig form full-length transcript sequences.

FIGS. 4A and 4B. Reducing the graph by collapsing FIG. 4A unipaths, which corresponds to transcribed segments shared by all isoforms; and FIG. 4B simple bubbles, which can be caused by either errors or exon skipping (or intron retention) events. In the case of errors, either v or w is removed. In the case of exon skipping, the node containing the extra exon(s) is kept. Note that after removing one of the nodes, u→v→t is now a unipath that can be reduced.

FIGS. 5A and 5B. Testing different k-mer sizes using Gencode simulated data with different error rates. Errors were assumed to be i.i.d. Mash was run with default parameters and a true hit is one for which the two transcripts are from the same gene, whereas a false hit is between transcripts that are from different genes, even if the two genes are homologous. FIG. 5A Low k-mer sizes increase sensitivity of same-gene transcripts (solid lines) and the effect is more dramatic at high error rates; on the other hand, specificity (dashed lines) varies little after 5% similarity cutoff FIG. 5B Number of entries (including self hits and symmetric hits) Mash produced for different k-mer sizes at different error rates.

FIG. 6. Fraction of transcripts with recurrent k-mers using Gencode simulated data. Setting a higher k-mer means there's less chance that a transcript may have the same k-mer appear more than once. Higher simulated errors rates slightly reduce the k-mer recurrence.

FIG. 7. Loci complexity for the three datasets. See also Table 1 for additional details.

FIG. 8. Example of gene being partitioned by Cogent into two partitions. The HAP1 gene in the Gencode dataset shows two distinct isoform grouping patterns. The isoforms HAP1.003, HAP1.004, and HAP1.005 share the same alternative 3′ end whereas HAP1.001, HAP1.002, HAP1.006 and HAP1.007 share a common 5′ and 3′ exon structure. As a result, Cogent partitioned the gene into two {HAP1.003, HAP1.004, HAP1.005} and {HAP1.001, HAP1.002, HAP1.006, HAP1.007}.

FIGS. 9A, 9B, and 9C. Cogent reconstruction example for GENCODE. The input transcripts and the reconstructed Cogent contigs are mapped back to hg19 genome for evaluation. FIG. 9A The CPSF3L family contains 24 input transcripts (top bracket) and was successfully reconstructed into a single Cogent contig (bottom arrow). FIG. 9B In the Cogent-centric view, alternatively spliced exons are visualized but common introns are not visible. FIG. 9C The KRT222 gene contains only 3 transcripts (top bracket) but had alternative 3′ ends that could not be resolved using transcriptome data only, resulting in two Cogent contigs (bottom bracket).

FIGS. 10A and 10B. Cogent reconstruction examples for fungal data. The input transcripts (top bracket) and the reconstructed Cogent contigs (bottom bracket) are mapped back to Plicr1 genome for evaluation. The input consisted of two separate genes, one from scaffold_1 FIG. 10A and one from scaffold_11 FIG. 10B. Reconstruction reflected the mixed source, where two contigs were each reconstructed for scaffold_1 (FIG. 10A; bottom bracket) and scaffold_11 (FIG. 10B; bottom bracket), respectively.

### DETAILED DESCRIPTION OF THE INVENTION

Various embodiments and components of the present invention employ signal and data analysis techniques that are familiar in a number of technical fields. For clarity of description, details of known analysis techniques are not provided herein. These techniques are discussed in a number of available reference works, such as: R. B. Ash. Real Analysis and Probability. Academic Press, New York, 1972; D. T. Bertsekas and J. N. Tsitsiklis. Introduction to Probability. 2002; K. L. Chung. Markov Chains with Stationary Transition Probabilities, 1967; W. B. Davenport and W. L Root. An Introduction to the Theory of Random Signals and Noise. McGraw-Hill, New York, 1958; S. M. Kay, Fundamentals of Statistical Processing, Vols. 1-2, (Hardcover—1998); Monsoon H. Hayes, Statistical Digital Signal Processing and Modeling, 1996; Introduction to Statistical Signal Processing by R. M. Gray and L. D. Davisson; Modern Spectral Estimation: Theory and Application/Book and Disk (Prentice-Hall Signal Processing Series) by Steven M. Kay (Hardcover—January 1988); Modern Spectral Estimation: Theory and Application by Steven M. Kay (Paperback—March 1999); Spectral Analysis and Filter Theory in Applied Geophysics by Burkhard Buttkus (Hardcover—May 11, 2000); Spectral Analysis for Physical Applications by Donald B. Percival and Andrew T. Walden (Paperback—Jun. 25, 1993); Astronomical Image and Data Analysis (Astronomy and Astrophysics Library) by J. L. Starck and F. Murtagh (Hardcover—Sep. 25, 2006); Spectral Techniques In Proteomics by Daniel S. Sem (Hardcover—Mar. 30, 2007); Exploration and Analysis of DNA Microarray and Protein Array Data (Wiley Series in Probability and Statistics) by Dhammika Amaratunga and Javier Cabrera (Hardcover—Oct. 21, 2003).

### Computer Implementation

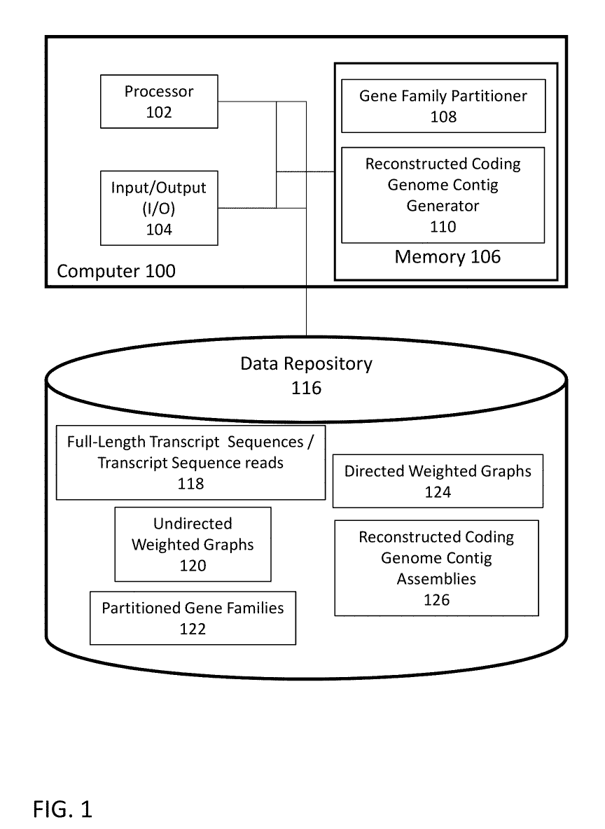

FIG. 1 is a diagram illustrating one embodiment of a computer system for implementing a process for generating a reconstructed coding genome contig for a gene family from a set of full-length transcript sequences (see, e.g., US Patent Publication No. US 2015/0178446 entitled “Iterative Clustering of Sequence Reads for Error Correction” for an exemplary description of full-length transcript sequences, hereby incorporated by reference herein in its entirety). In specific embodiments, the invention may be embodied in whole or in part as software recorded on fixed media. The computer 100 may be any electronic device having at least one processor 102 (e.g., CPU and the like), a memory 106, input/output module (I/O) 104. In some embodiments, the system includes a separate data repository 116. The components of the system processor 102, the memory 103, the I/O 104, and, where included, the data repository 116 may be connected via a system bus or buses, or alternatively using any type of communication connection. Although not shown, the computer 100 may also include a network interface for wired and/or wireless communication. In one embodiment, computer 100 may comprise a personal computer (e.g., desktop, laptop, tablet etc.), a server, a client computer, or wearable device. In another embodiment the computer 100 may comprise any type of information appliance for interacting with a remote data application, and could include such devices as an internet-enabled television, cell phone, and the like.

The processor 102 controls operation of the computer 100 and may read information (e.g., instructions and/or data) from the memory 106 and/or the data repository 116 and execute the instructions accordingly to implement the exemplary embodiments. The term “processor 102” is intended to include one processor, multiple processors, or one or more processors with multiple cores.

The I/O 104 may include any type of input devices such as a keyboard, a mouse, a microphone, etc., and any type of output devices such as a monitor and a printer, for example. In an embodiment where the computer 100 comprises a server, the output devices may be coupled to a local client computer.

The memory 106 may comprise any type of static or dynamic memory, including flash memory, DRAM, SRAM, and the like. The memory 106 may store programs and data including a gene family partitioner 108 and a reconstructed coding genome contig generator 110. These components, and their underlying algorithms, may be used in the process of generating a reconstructed coding genome contig for one or more gene families from a set of full-length transcript sequences as described herein.

The data repository 116 may store several databases including one or more databases that store full-length transcript sequences or transcript sequence reads 118, undirected weighted graphs 120, partitioned gene families 122, directed weighted graphs 124, and/or reconstructed coding genome contig assemblies 126. The full-length transcript sequences/sequence reads 118 comprise isoform sequence reads, e.g., full-length transcript isoform sequences from one or more gene/gene family.

In one embodiment, the data repository 116 may reside within the computer 100. In another embodiment, the data repository 116 may be connected to the computer 100 via a network port or external drive. The data repository 116 may comprise a separate server or any type of memory storage device (e.g., a disk-type optical or magnetic media, solid state dynamic or static memory, and the like). The data repository 116 may optionally comprise multiple auxiliary memory devices, e.g., for separate storage of input sequences (e.g., sequence reads), sequence information, calculation results and/or other information. Computer 100 can thereafter use that information to direct server or client logic, as understood in the art, to embody aspects of the invention.

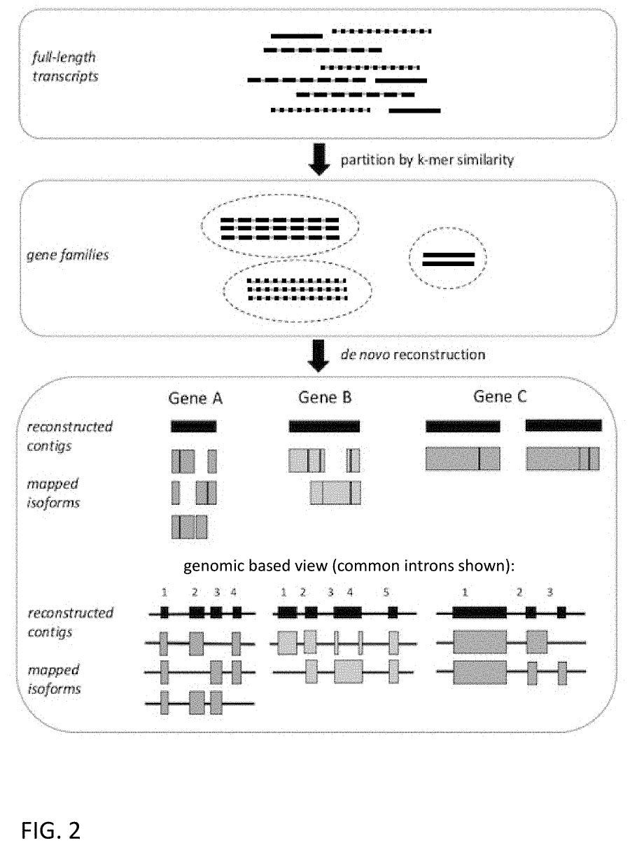

In operation, an operator may interact with the computer 100 via a user interface presented on a display screen (not shown), e.g., to input or specify the full-length transcript sequence reads and other parameters required by the various software programs. The full-length transcript sequences can be entered by the user or selected by the user from sequences in the full-length transcript sequence data 118. Once invoked, the programs in the memory 106, including the gene family partitioner 108 and the reconstructed coding genome contig generator 110, are executed by the processor 102 to implement the methods of the present invention. FIG. 2 shows the basic workflow for the disclosed Coding Genome Reconstruction Tool (sometimes referred to herein as Cogent). Given a set of full-length transcript sequences either retrieved from data repository 116, input from a user, or both, (FIG. 2 top panel), Cogent first partitions the sequences into gene families using gene family partitioner 108 (FIG. 2 middle panel), then reconstructs the transcribed regions for each gene based on the alignment of the full length transcripts for each gene family using reconstructed coding genome contig generator 110 (FIG. 2 bottom panel). For gene A and B in FIG. 2, perfect reconstruction (1 contig) is achieved. For gene C, however, there is insufficient information to perfectly resolve the extended 3′ ends, resulting in two separate contigs.

In certain embodiments, the undirected graph generator 108 reads the selected full-length transcript sequence reads, e.g., from the data repository 116, and performs sequence similarity analysis/alignment on the sequence reads to identify regions of similarity and forms an undirected graph. In one embodiment, the full-length reads 116 are high accuracy reads, e.g., at least about 98% or 99% accurate, and may be raw reads from a sequencing technology that provides such high quality reads, or may be pre-assembled, high-quality reads constructed from sequencing read data of a lower quality. Aligned sequences can be generated by any convenient sequence aligner/graph generator algorithm residing in gene family partitioner 108. In certain embodiments, the sequence aligner/graph generator is implemented in C, C++, Cobol, Pascal, Java, Java-script, C#, F#, Python, Perl, Haskell, Scala, Lisp, a Python/C hybrid, HTML, XML, dHTML, assembly or machine code programming, RTL, or any other convenient computer language or combination of languages known in the art.

The output of the processing may include one or more reconstructed coding genome contig assembly, which can be saved to the memory 103 and/or stored in data repository 116 (element 126). In one embodiment, representative full-length transcript sequences that were used to generate the reconstructed coding genome contig are aligned to it and output through the I/O 104 for display on a display device and/or saved to an additional storage device (e.g., CD, DVD, Blu-ray, flash memory card, etc.), or printed. In certain embodiments, the reconstructed coding genome contig assembly is displayed graphically (e.g., as shown in FIG. 2, bottom panel). As noted above, there are cases when the transcribed region for a particular locus cannot be resolved unambiguously. Reasons for this include lack of connectivity information, gene duplications, and unresolved errors. In the example shown in FIG. 2, gene A and B are fully resolvable, but for gene C, which has two isoforms with alternative 3′ ends, there is not enough information to resolve their order. In embodiments with such ambiguity, the minimal set of contigs that can fully explain the isoforms can be output to the user.

### Methods

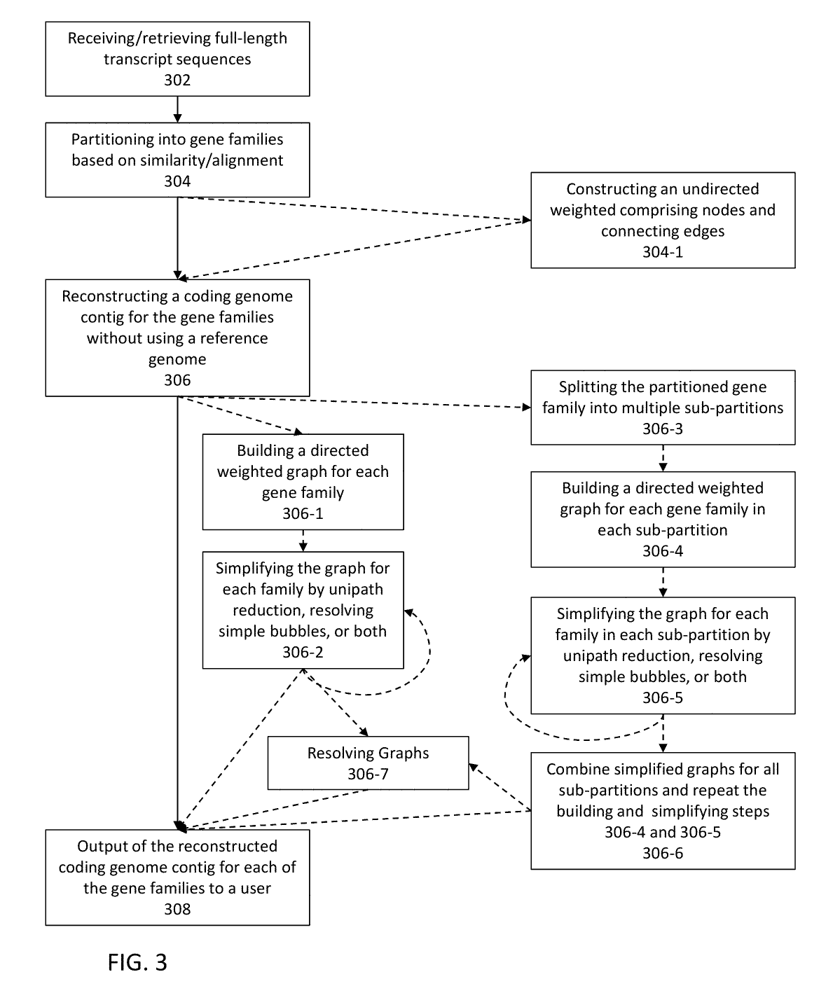

FIG. 3 is a flow diagram illustrating certain aspects of a process for reconstructing a coding genome contig from full-length transcript sequences without a reference genome according to an exemplary embodiment. The process may be performed by a combination of the gene family partitioner 108 and the reconstructed coding genome contig generator 110 (shown in FIG. 1). While these are shown as separate components, the functionality of each may be combined into a single software/algorithm or multiple different software algorithms/components.

As shown in FIG. 3, the process may begin by receiving/retrieving a set of full length transcript sequences/sequence reads 302, which can be directly from input of a user or from memory 103 or data repository 116 (element 118) as in FIG. 1. In certain embodiments, the input dataset for the process shown in FIG. 3 is a set of full-length transcript sequences of any length originating from a sample and representing one or more genes. Any desired sample may be used and can include samples from a single source or multiple different sources. Where transcript sequences from multiple different sources are being analyzed, they are generally from the same species. Where different sources are used, the transcript sequences may further include barcode sequences that can be used to identify the specific source of the transcript by deconvolution. The sample can be from a single cell, multiple cells, a population of organisms, one or more tissues (e.g., liquid or solid biopsy samples), etc. The sequences can be high accuracy sequences, e.g., having an accuracy of ≥99%. The output from a Cogent analysis of full-length transcript sequences includes the reconstructed coding genome contig(s) (i.e., contig(s) that compose the transcribed regions) for each gene family partition identified. In some embodiments, the full-length transcript sequences that comprise each gene family partition are also output. The output can be provided in any useful display format and generally includes a graphical representation of the aligned contig/transcript sequences (see Example section and the figures described therein).

The full-length sequences are analyzed and partitioned into gene families based on sequence similarity/alignment using any convenient algorithm(s) (304). Each partitioned gene family is then analyzed to reconstruct a coding genome contig without reliance on a reference genome to aid in the reconstruction (306). The reconstructed coding genome contig(s) for each gene family identified is then output to a user (308). While the description below provides exemplary methods and algorithms for achieving each of these steps, variations of these specific embodiments are not meant to be excluded. For example, U.S. Patent Publication No. US 2015/0302144, entitled “Hierarchical Genome Assembly Method Using Single Long Insert Library” (U.S. application Ser. No. 14/716,617) provides a description of certain algorithms for sequence comparison and alignment that may find use in aspects of the present disclosure, and is hereby incorporated by reference herein in its entirety.

### Partitioning into Gene Families Using k-mer Similarity

In this embodiments, an undirected weighted graph is constructed where each node represents a transcript and connecting edges between each node has a weight that is the proportion of shared unique k-mers (i.e., number of aligned/overlapping bases) (step 304-1 in FIG. 3). In certain embodiments, the k-mer calculation can be sped up using Mash (MinHash), which is a locality-sensitive hashing procedure for quickly identifying sequence similarities on a large scale (Ondov et al. 2015). The default sketch size for Mash can be set at from about 500 to 2000, (e.g., 1000) and the k-mer size can be set from about 10 to 30 (e.g., 12 to 20, e.g., 16) and approximate sequence similarity based on the percentage of matching k-mer sketches (see the Examples for a specific use of these parameters). Once the graph is constructed, a normalized cut technique developed for image segmentation by Shi & Malik (Shi and Malik 2000) can be used. This technique uses a cost function designed to balance between minimizing the number of edges that cross between the partitions versus the size of the partitions. For further speed up, one can first identify connected components in the graph and then apply a normalized cut to each component.

### Graph Reconstruction

As indicated above, each partitioned gene family is analyzed to reconstruct a coding genome contig without using a reference genome to aid in the reconstruction (306). In certain embodiments, this includes building a directed weighted graph for each gene family (306-1 in FIG. 3) followed by simplifying the graph for each family by unipath reduction, resolving simple bubbles, or both (306-2 in FIG. 3).

In certain embodiments, the reconstruction process begins by constructing a de Bruijn graph G where each node represents a unique k-mer and each directed edge between two nodes (u, v) indicates a match of suffix of u with prefix of v. The value fork can be selected by a user, where in certain embodiments, k is from about 20 to about 80 bases, e.g., from 30 to 60, from 40 to 50, etc. In the Example shown below, k=40 by default. The length of the overlap is k−1. This is done by traversing the set of input transcript sequences S={S₁, S₂, . . . Sₘ}. Each sequence can then be represented as a path through G, denoted: Path(Sᵢ)=pᵢ=u→v→w→ . . . →t. P is denoted as the whole set of paths for S. At any point in time in the algorithm, for every transcript Sᵢ, there must be a valid path pᵢ through G such that the sequence represented by pᵢ can “explain” Sᵢ. Precisely, it means that one can divide Sᵢ=x₁x₂ . . . xₖ where the sequence represented by pᵢ is sequence (pᵢ)=y₁x₁y₂x₂ . . . yₖxₖyₖ₊₁ where each yⱼ is a sequences of length 0 or more; in other words, pᵢ is an expansion of Sᵢ that preserves the order x₁, x₂, . . . xₖ.

In this analysis, the assumption is that G is an acyclic directed graph. Cycles in the graph would make path traversals very complicated. Two exceptions to this can be made. The first is for homopolymers of length≥k. In certain embodiments, these homopolymers are detected in the sequences in advance and replace with nodes that present the full homopolymer. The second is for k-mers that occur more than once in the same sequence. In certain embodiments, these repeat k-mers can be detect by looking at the path for that sequence and replacing the section of the path (and the corresponding nodes in the graph) sandwiched between the first and last recurring k-mer with a single node that represents that subsequence.

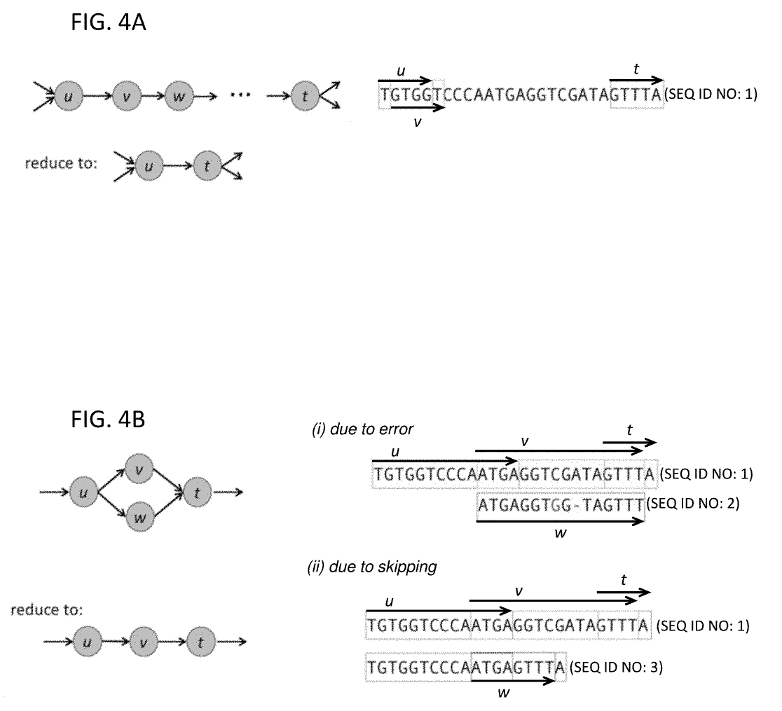

After the initial construction (306-1 in FIG. 3, described above), the graph can be simplified through (i) uni-path contraction; (ii) simple bubble collapse, or both (306-2 in FIG. 3). A simple bubble in the graph can be due to either sequencing error, true SNP variation, or exon skipping. FIGS. 4A and 4B show examples of these processes and are described below.

### 1. Unipath Reduction

A unipath in a graph is continuous path u→v→w→ . . . →s→t where u has only one outgoing edge, t has only one incoming edge, and all the intermediate nodes have exactly one incoming and one outgoing edge (see FIG. 4A). The unipath in FIG. 4A can be contracted, for example, by updating the sequence that u represents by deleting the nodes v through s, i.e., the intermediate nodes that have exactly one incoming and one outgoing edge. This simplifies the path down to u→t. At the same time, we update P, i.e., the set of paths pᵢ for each sequence i. For any pᵢ that contains one or more of the nodes in the unipath, that portion with the connection u→t is replaced. Note that by replacing it with the contracted edge, the encoding sequence for pᵢ may now contain extra sequences. Yet this pᵢ will still “explain” the transcript Sᵢ.

### 2. Resolving Simple Bubbles

Simple bubbles in a unipath can be due to a number of underlying sequence characteristics, including sequence errors, actual SNP variations, exon skipping, and the like. In general, a simple bubble is identified by looking for two nodes that share the same exact predecessor node and successor node (FIG. 4B; nodes v and w share the same predecessor u and successor t). If the bubble is caused by sequence errors or minor variants (see FIG. 4B, panel (i)), then the two nodes must share very similar sequences. The sequences represented by the two nodes can be aligned, e.g., using a sparse Smith-Watermann algorithm (Zhao et al. 2013). If the two nodes are considered the same, then either the two nodes are merged or one node is removed and P is updated (in FIG. 4B, the shorter node w with the “error” is removed). In certain embodiments, the algorithm used allows the user to specify a weight (typically the number of reads supporting the transcript sequence) to do a majority consensus when merging nodes; more elaborate consensus calling schemes such as using DAGCon (Chin et al. 2013) is also possible. Note that minor true biological variations will not be distinguished from errors at this stage. True biological variants, e.g. SNPs, can be recovered either using a refined final consensus calling or done separately after reconstruction.

A bubble that is caused by exon skipping or intron retention can be identified by observing one node consisting entirely of the suffix of the predecessor and the prefix of the successor and one node consisting of the suffix of the predecessor, the extra exon, and the prefix of the successor (see FIG. 4B, panel (ii)). In this case, the node missing the exon (i.e., the shorter exon; node win FIG. 4B) is removed and replaced with the exon-containing node.

It is noted that errors or exon-skipping events at the beginning or end of sequences will look like “branches” instead of bubbles in the graphs described above. For the beginning of sequences, it is two source nodes going to a common successor. For the end of sequences, it is a common predecessor node going to two sink nodes. Detecting and resolving these special cases can be done in a manner similar to resolving bubbles, as described above. Thus, “resolving bubbles” includes resolving these “branches” at the beginning and end of a sequence.

After the first round of resolving simple bubbles has taken place, the updated graph can be subjected to additional rounds of simplification until the graph cannot be further reduced (this is represented in FIG. 3 as the dotted curved arrow indicating a repeat at step 306-2).

For very large gene family partitions, the simplified graph may be so complicated that even after reduction it still produces an exponentially large number of possible paths. In such embodiments, such large partitions can be split into smaller, separate problems which are solved independently (see steps 306-3, 306-4, and 306-5). Once each of these sub-partitions are reduced/simplified, their reconstructed outputs can be combined to serve as input to final round of reconstruction (step 306-6). The algorithm employed can be set to generate sub-partitions having any desired number or range of full-length transcript sequences, e.g., from about 10 to about 50, e.g., about 20.

### 3. Graph Resolution Using a Parsimonious Approach

In the case of sufficient information and no errors, the graph resulting from the simplifying step will be reduced to one node that represents the reconstructed contig which will be output to one or more users (indicated in FIG. 3 by dotted arrows directly from steps 306-2 and 306-6 to step 308).

In many cases, however, unresolved errors, lack of connectivity, and actual gene duplication events, will leave the graph only partially resolved after simplification. In such embodiments, the unresolved graphs are sent to resolving step 306-7, where the minimal number of reconstructed contigs that fully explains the input dataset are generated and output to one or more user.

In certain embodiments, a parsimonious approach is used for resolving the graphs. In these embodiments, resolving includes traversing all paths A={a₁, a₂, a₃ . . . } from all source nodes to all sink nodes. With the exception of very large gene families, most graphs at this point are down to a dozen nodes with an average degree of just less than 1.5. As such, traversal of all paths is not computationally costly. Next, a compatibility matrix M is constructed where M(i,j)=1 if the aⱼ can “explain” the transcript i. Using the path pᵢ for transcript sequence i (which has been updated throughout the graph reduction steps above), aⱼ is said to “explain” pᵢ if it contains all the nodes in pᵢ with the same ordering but may contain additional nodes. This is the same criterion used for updating P throughout the graph reduction process described above. The problem of finding the minimal set of paths in A to fully explain P can then be formulated as a binary linear programming (LP) question. Binary variable bⱼ is used to denote whether or not to include aⱼ in the final output as follows:

minimize Σⱼ bⱼ
subject to Σⱼ M(i, j)bⱼ ≥ 1 ∀ i = 1,2, ... m
and bⱼ ∈ {0,1}

The sequences encoded by aj for which bj=1 are output by an LP solver (Mitchell et al., n.d.). As a final reduction step, the splice-aware aligner GMAP (Wu and Watanabe 2005) is used to align all transcript sequences to the output. The GMAP parameter can be set such that multiple alignment results can be reported. In certain embodiments, a second compatibility matrix is constructed to solve a second LP to cut down to the final set of reconstructed contigs.

We note here that it is not desirable to either (i) simply output all paths after the graph reduction step, run GMAP, followed by the LP formulation, or (ii) simply deduce contigs from aligner outputs without LP optimization because most, if not all, aligners to date employ heuristics to speed up cases of multi-mapping cases. This means that when there are highly similar matches, which is the case for the problem being solved herein, aligners often fail to exhaustively output all answers, and may in fact miss the optimal solution.

### Computer Readable Media

In some embodiments, the present disclosure provides a non-transient computer-readable medium that stores instructions for execution, by one or more processor, of steps for reconstructing a coding genome contig from full-length transcript sequences as described herein. In certain embodiments, the computer readable medium is operatively coupled to a processor in a system as described above. The instructions may include one or more of the following: instructions for receiving input of full-length transcript sequences/sequence reads, instructions for partitioning the sequences into gene families based on similarity/alignment (e.g., constructing an undirected weighted comprising nodes and connecting edges), instructions for reconstructing a coding genome contig for the gene families without using a reference genome (e.g., building a directed weighted graph for each gene family; simplifying the graph for each family by unipath reduction, resolving simple bubbles, or both; and/or resolving graphs, e.g., by a parsimonious approach), and outputting a reconstructed coding genome contig for one or more gene families to a user. To perform these method steps, these instructions can further include: instructions aligning sequence reads, instructions for generating unitig graphs, instructions for identifying string bundles, instructions for generating consensus sequences, instructions that compute/store information related to various steps of the method (e.g., edges and nodes in a string graph, overlaps and branch points in a string graph, and instructions that record the results of the method.

In certain aspects, the methods are computer-implemented methods. In certain aspects, the algorithm and/or results (e.g., reconstructed coding genome contigs) are stored on computer-readable medium, and/or displayed on a screen or on a paper print-out. In certain aspects, the results are further analyzed, e.g., to identify genetic variants, to identify one or more origins of the sequence information, to identify genomic regions conserved between individuals or species, to determine relatedness between two individuals, to provide an individual with a diagnosis or prognosis, or to provide a health care professional with information useful for determining an appropriate therapeutic strategy for a patient.

Furthermore, the functional aspects of the invention that are implemented on a computer or other logic processing systems or circuits, as will be understood to one of ordinary skill in the art, may be implemented or accomplished using any appropriate implementation environment or programming language, such as C, C++, Cobol, Pascal, Java, Java-script, C#, F#, Python, Perl, Haskell, Scala, Lisp, a Python/C hybrid, HTML, XML, dHTML, assembly or machine code programming, RTL, or any other convenient computer language or combination of languages known in the art.

In certain embodiments, the computer-readable media may comprise any combination of a hard drive, auxiliary memory, external memory, server, database, portable memory device (CD-R, DVD, ZIP disk, flash memory cards, thumb drive, etc.), and the like.

In some aspects, the invention includes an article of manufacture for reconstituting coding genome contigs that includes a machine-readable medium containing one or more programs which when executed implement the steps of the invention as described herein.

### Utility

There are many possible uses to having a partially reconstructed genome. For one, it gives researchers a way to map the isoforms back and visualize exon skipping events. With the mapping, it also becomes possible to apply existing tools for phasing and variant calling. Finally, the reconstructed genome can likely help with resolving genome assembly issues, such as being used for scaffolding (Xue et al. 2013) or identify gene duplication events.

Finally, we note that Heber et al. (Heber et al. 2002) described encoding gene splice variants into a splice graph. However, Heber et al. was focused on representing EST—fragmented cDNA sequences—of the same gene into a unified graph structure and assembling them. The Heber et al. study was thus focused on transcript assembly and graph representation, whereas here we focus on genome reconstruction by outputting a linear consensus sequence.

It is to be understood that the above description is intended to be illustrative and not restrictive. It readily should be apparent to one skilled in the art that various modifications may be made to the invention disclosed in this application without departing from the scope and spirit of the invention. The scope of the invention should, therefore, be determined not with reference to the above description, but should instead be determined with reference to the appended claims, along with the full scope of equivalents to which such claims are entitled. Throughout the disclosure various references, patents, patent applications, and publications are cited. Unless otherwise indicated, each is hereby incorporated by reference in its entirety for all purposes. All publications mentioned herein are cited for the purpose of describing and disclosing reagents, methodologies and concepts that may be used in connection with the present invention. Nothing herein is to be construed as an admission that these references are prior art in relation to the inventions described herein.

### EXAMPLES

We applied Cogent to a simulated dataset to determine the effect of k-mer sizes on gene family partitioning and reconstruction. We determined the best k-mer sizes for partitioning and reconstruction, respectively, then used those parameters on two real full-length transcriptome datasets.

### Results

### 1. Effect of k-mer Size on Gene Family Partitioning and Reconstruction Using Simulated Data

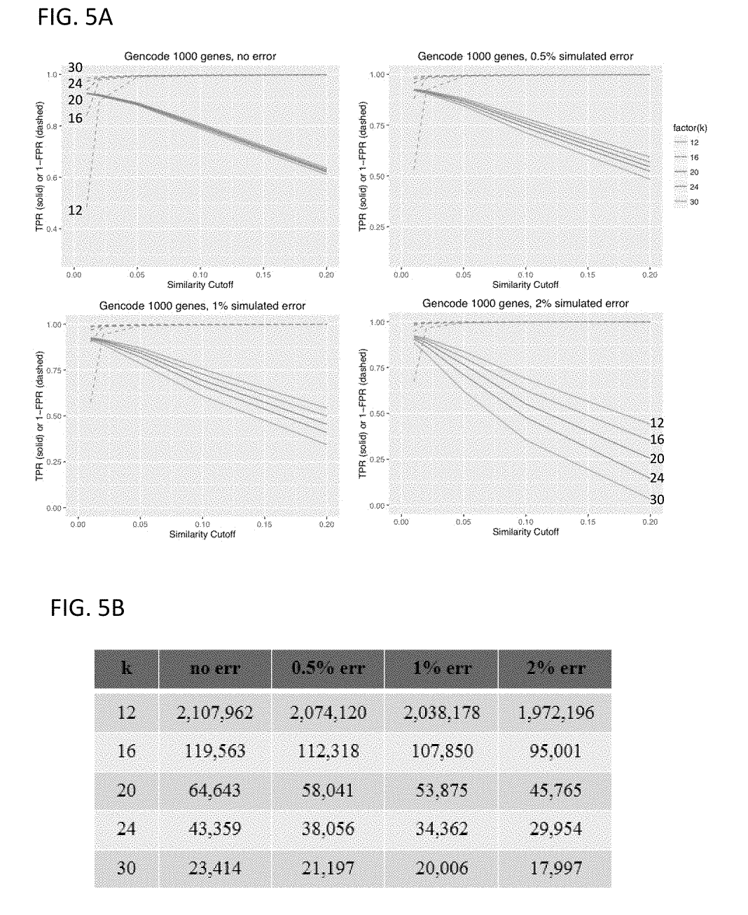

We generated a simulated dataset by selecting 1000 random gene families from Gencode (version19). Each gene family contained at least 2 isoforms (min: 38 bp, max: 18 kb, mean: 2.1 kb), forming a total of 15,694 homologous pairs. We simulated i.i.d. errors at 0.5%, 1%, and 2%, distributing the errors evenly among substitutions, insertions, and deletions. In FIG. 5A, we calculated and graphed the true positive rate (solid lines) and 1−false positive rate (dashed lines) at different similarity cutoffs. Above a cutoff of 0.05 (top left panel), there were essentially no false positives regardless of error rate (dashed lines); the size of k-mers also had no effect (k-mers sizes include 12, 16, 20, 24, and 30; the line order is listed on the top left panel for the dashed lines and on the bottom right panel for the solid lines; the line order is the same in each graph). Increasing the similarity cutoff gradually reduced true positive rate (solid lines), and smaller k-mer sizes had higher sensitivity, as can be expected. However, with smaller k-mer sizes, the number of spurious hits between non-homologous sequences increased, leading to an explosion in data size: at k=12, the number of hits is twenty-fold to the number of hits at k=16 (FIG. 5B), with only minimal improvement in true positive rate.

For reconstruction, we want to avoid having repetitive k-mers in the same sequence as they create cycles in our de Bruijn graph. The percentage of sequences in the simulated data that have recurrent k-mers (k-mers that appear more than once within the same sequence) drops from 45% at k=12 to below 5% at k=30, 2% at k=40, and below 2% at k=50 and above (FIG. 6). Larger k-mer sizes means less recurrences, but also more complicated graphs and more time spent resolving errors.

Based on these results, we set our parameters to k=16 and similarity cutoff of 0.05 for gene family partitioning and k=40 for reconstruction.

### 2. Cogent Gene Family Partitioning Is Fast and Accurate

We applied Cogent to three datasets: the entire Gencode v19 set, a human brain full-length transcriptome (PacificBiosciences 2014), and a published fungal full-length transcriptome dataset (Gordon et al. 2015). Table 1 lists an evaluation dataset for Cogent gene family partitioning. Gencode (v19) is based on the reference genome and hence errorless. We removed duplicate sequences, resulting in a total of 95,156 unique Gencode transcripts from 20,575 genes. The human brain and fungal dataset accuracy was estimated by aligning back to hg19 and Plicr1 reference genome, respectively. An improved reference genome for Plicr1 was released after the transcriptome dataset was published, and is used here to realign the transcripts and determine the gene loci. For Gencode, genes/loci are determined by the given annotated gene name. For the human brain and fungal dataset, genes/loci are determined by grouping all overlapping transcripts (strand-specific), which may include multiple genes if the genes overlap or there are polycistronic transcripts that cover several consecutive genes (in the fungal paper, >100 polycistronic transcripts were discovered).

TABLE 1

| Sample | GENCODE | Human Brain | Fungal |
|---|---|---|---|
| Transcripts | 95156 | 10289 | 19410 |
| Genes/Loci | 20575 | 6356 | 8318 |
| # of loci w/1 | 4947 | 4333 | 4208 |
| transcript | | | |
| (size = 1) | | | |
| # of loci w/2+ | 15628 | 2023 | 4110 |
| transcripts | | | |
| (size ≥ 2) | | | |
| Avg. # of | 4.6 | 1.6 | 2.3 |
| isoforms per | | | |
| loci | | | |
| Lengths | 8 bp-109 kb | 418 bp-8.8 kb | 219 bp-5.6 kb |
| Accuracy | 100% | 76-100% | 84-100% |
| | (reference) | avg: 99.6% | avg: 99.7% |

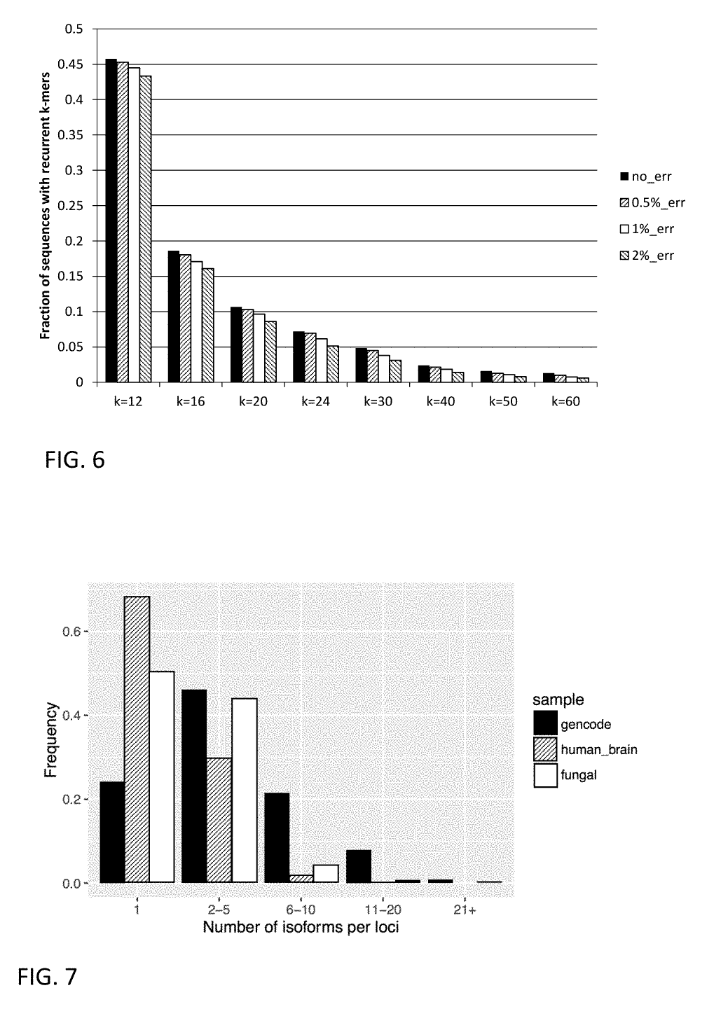

As shown in Table 1, the estimated accuracies of the transcriptome datasets are 99.6% and 99.7%. For Gencode, we used the annotated gene name as the ground truth. For the human brain and fungal dataset, we grouped the transcripts by loci (strand-specific) and treated each non-overlapping-loci as a single gene. An improved reference genome for the fungal dataset (Plicr1) was released after transcriptome publication and was used to re-align the transcript sequences to determine their mapping loci (Kohler et al. 2015). Gencode was the most complex of the dataset, containing an average of 4.6 isoforms per loci. Even the fungal dataset contained an average of 2.3 isoforms per loci. The human brain dataset was the simplest, likely due to the dataset being of lower sequencing depth and is limited to one tissue (FIG. 7).

We applied Cogent gene family partitioning and computed the recall and precision of the partitioning using the formula from (Vilain et al. 2005). Briefly, recall and precision was calculated using the formulae below, where genomePartition is the genome-based assignment of transcripts to genes/loci, and denovoPartition is the Cogent assignment. The mucF score is calculated normally.

$$mucRecall ( genomeParticion , denovoPartition ) = \frac{{Σ}_{c in genomePartition} ( size ( c ) - overlap ( c , denovoPartition ) )}{{Σ}_{c in genomePartition} ( size ( c ) - 1 )}$$

$$mucPrecision ( genomePartition , denovoPartition ) = \frac{{Σ}_{c in denovoPartition} ( size ( c ) - overlap ( c , genomePartition ) )}{{Σ}_{c in denovoPartition} ( size ( c ) - 1 )}$$

We also ran CD-HIT-EST (Fu et al. 2012) to compare runtime and performance. CD-HIT-EST was run with the lowest identity cutoff allowed, which is 0.8. CD-HIT-EST was prone to under-clustering (separating a single gene family into many clusters), which gave it slightly higher precision but much worse recall (see Table 2 and Table 3).

TABLE 2

| | GENCODE | | Human Brain | | Fungal | |
|---|---|---|---|---|---|---|
| | Cogent | CD-HIT-EST | Cogent | CD-HIT-EST | Cogent | CD-HIT-EST |
| recall | 0.967 | 0.726 | 0.978 | 0.807 | 0.897 | 0.803 |
| precision | 0.972 | 0.962 | 0.942 | 0.956 | 0.941 | 0.950 |
| F-score | 0.969 | 0.828 | 0.960 | 0.875 | 0.918 | 0.870 |

As shown in Table 2, Cogent identifies gene families with high recall and precision. CD-HIT-EST, on the other hand, tends to undercluster resulting in low recall but mildly better precision.

TABLE 3

| Number of | GENCODE | | Human Brain | | Fungal | |
|---|---|---|---|---|---|---|
| Partitions | Cogent | CD-HIT-EST | Cogent | CD-HIT-EST | Cogent | CD-HIT-EST |
| Size = 1 | 5299 | 21091 | 4141 | 5062 | 4157 | 5440 |
| Size ≥ 2 | 15661 | 17772 | 2064 | 1905 | 4676 | 4593 |
| Total | 20960 | 38863 | 6205 | 6967 | 8833 | 10033 |

As shown in Table 3, CD-HIT-EST tended to undercluster, resulting in a lot of size=1 partitions (singletons). Meanwhile, Cogent produced partitions that closely represented the actual number of loci.

For the purpose of subsequent reconstruction, we would much rather have higher recall (better ability to identify homologous sequences) than higher precision. As an example, a program that simply outputs a singleton cluster for every sequence would achieve a precision of 1.0 but have the lowest recall possible. On all three datasets, Cogent ran faster than CD-HIT-EST and used less memory (Table 4).

TABLE 4

| | GENCODE | | Human Brain | | Fungal | |
|---|---|---|---|---|---|---|
| | Cogent | CD-HIT-EST | Cogent | CD-HIT-EST | Cogent | CD-HIT-EST |
| Runtime (sec) | 9519 | 42783 | 218 | 3621 | 650 | 3722 |
| Memory (GB) | 1502 | 2263 | 156 | 1014 | 247 | 1015 |

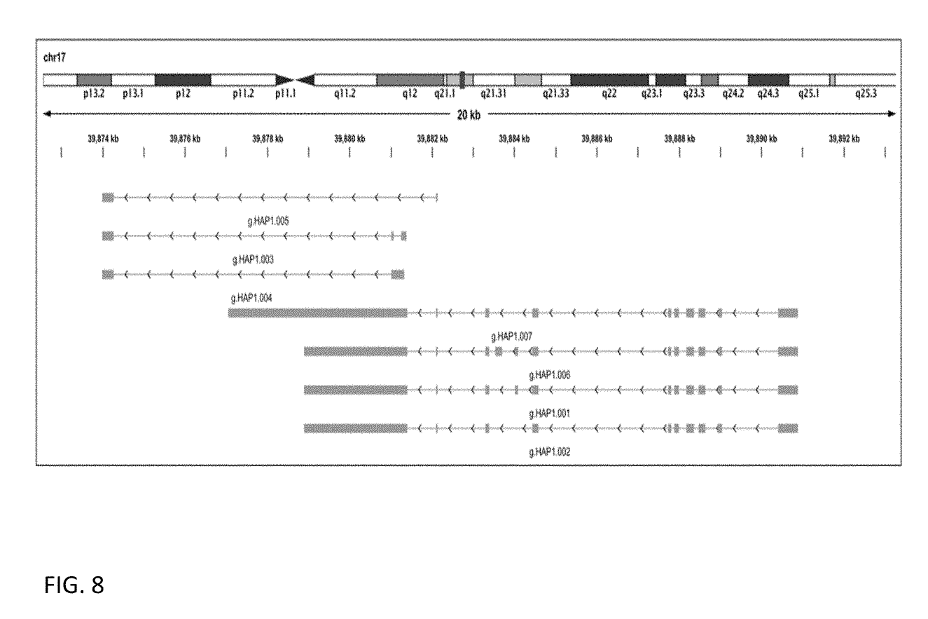

The number of partitions produced by Cogent was very close to the ground truth as given by the reference genomes (Table 1, Table 3). While for many genes, Cogent was able to perfectly capture them into a single partition, there are natural cases in which a single gene may be presented into two partitions. The HAP1 gene in GENCODE, for example, consists of 7 isoforms with two sets of distinct splice patterns (FIG. 8). On the other hand, the human genome is full of highly similar genes. Two genes, TBC1D26 and TBC1D28, have a within-gene similarity of 56-92%, yet across gene (one isoform from the first gene to another) their sequence similarities can go up to 99% (data not shown). In such cases, Cogent will group the two genes into a single partition. To be able to differentiate gene families at such fine level will likely require more than just the transcript sequences.

### 3. Cogent Efficiently Reconstructs the Coding Genome

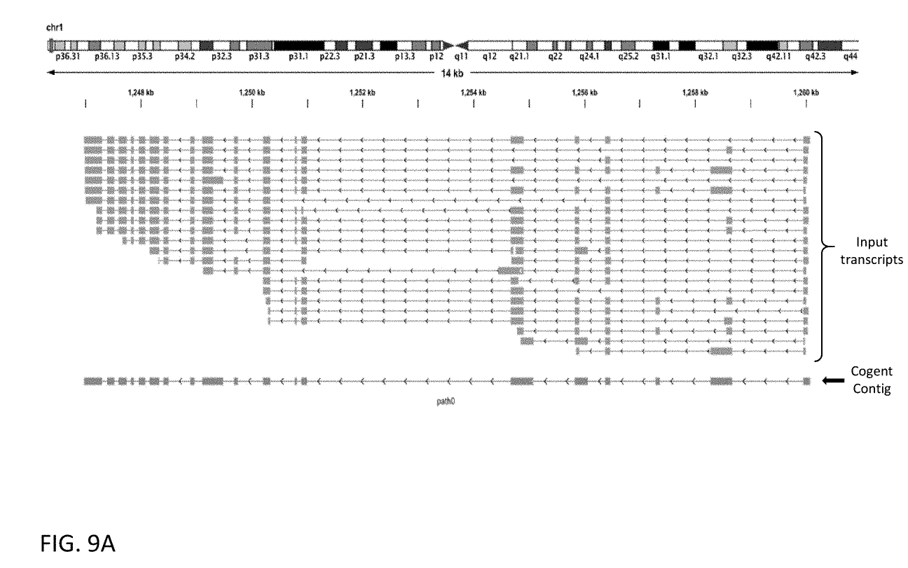

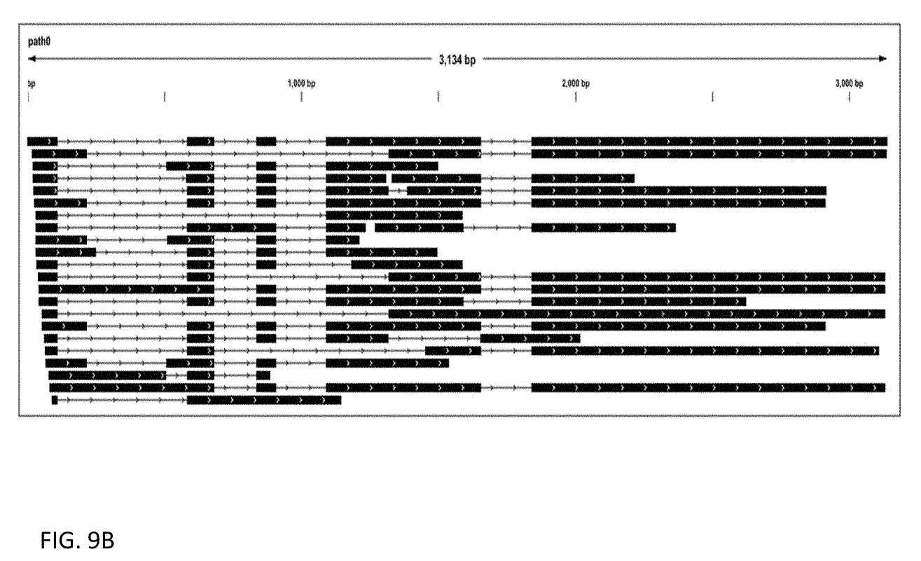

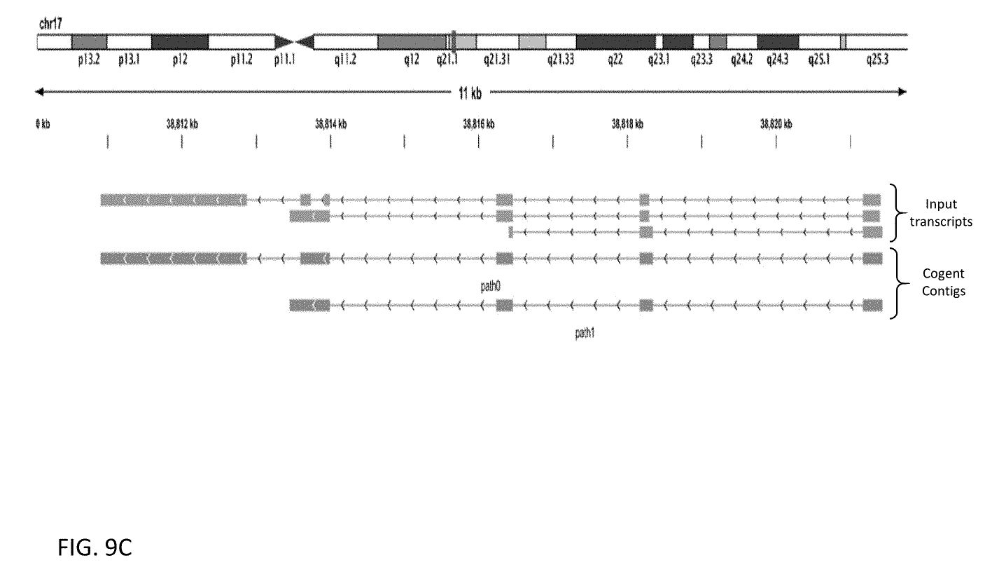

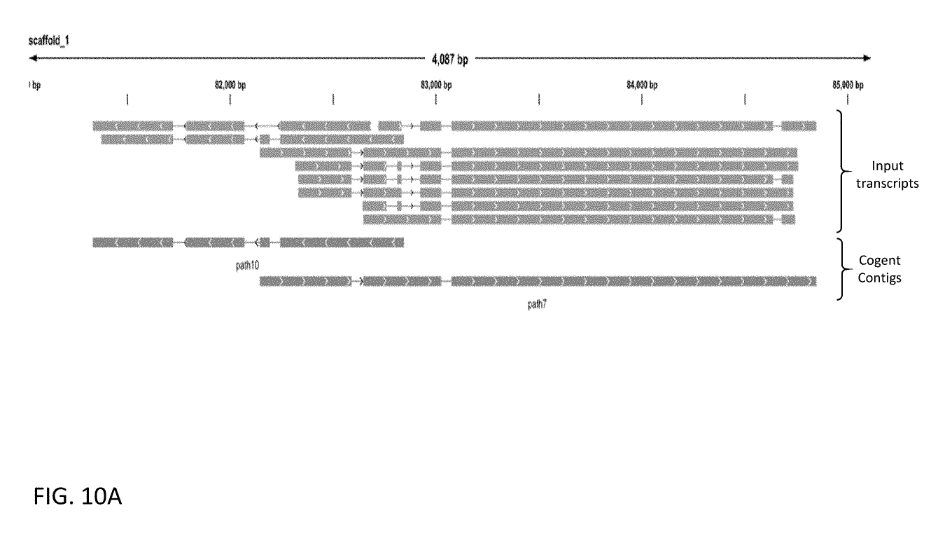

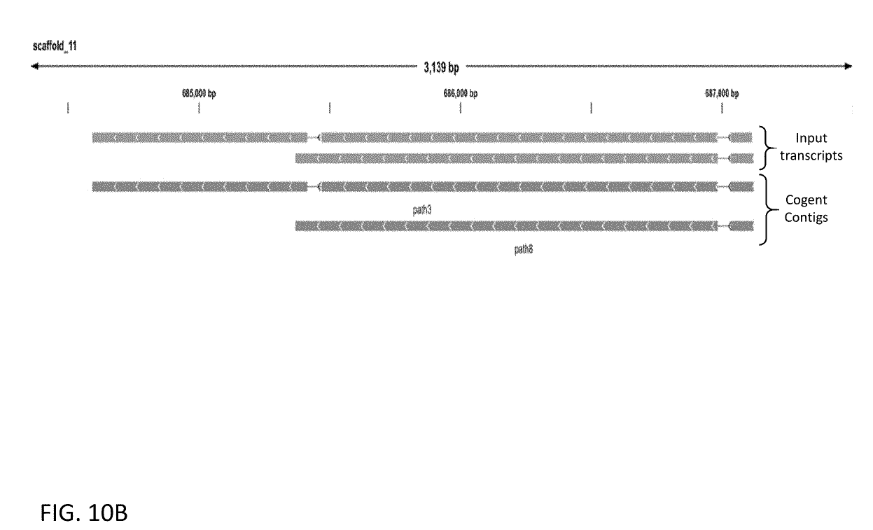

We evaluated correctness of the reconstructed contigs using the reference genome. All Cogent partitions from the three datasets that contain at least two transcripts (second row in Table 3) are run through reconstruction. A correctly reconstructed contig must map back to the same genomic loci as the input transcript sequences. We define a contig as correct if the following criteria are met: (a) the contig is mapped continuously to a single genomic locus; (b) each mapped segment of the contig corresponds to a transcribed portion of the locus as supported by the input transcript mappings. With the contig correctness defined, we evaluate the performance of each gene family partition, which may contain multiple reconstructed contigs. Consider that if a partition contains transcripts from genes/loci A and B, the reconstructed contigs must also map back to loci A and B (FIGS. 10A and 10B). If similarity between the genes are high, Cogent may accidentally collapse them, resulting in fusion contigs. Also consider that even if the partition contains only a single gene, lack of exon connectivity information or base errors can still lead to multiple contigs; in these cases, the reconstruction is not incorrect but is redundant (FIG. 9C). For each partition, we consider it “correct: precise” if it contains exactly 1 reconstructed correct contig for each locus; “correct: redundant” if it covers all the loci but reconstructed more than one correct contigs per locus; finally, the reconstruction is “incorrect” if the contigs mapped chimerically or to loci other than what was expected.

Reconstruction was correct for 99% of partitions for all three datasets (Table 5).

TABLE 5

| | | GENCODE | Human Brain | Fungal |
|---|---|---|---|---|
| Correct | Precise | 5186 | 1399 | 3524 |
| | Redundant | 10259 | 642 | 1136 |

| | | | |
|---|---|---|---|
| Incorrect | 215 | 23 | 16 |
| TOTAL | 15660 | 2064 | 4676 |

As shown in Table 5, Cogent correctly reconstructs 99% of the partitions in all three datasets. About ⅓ of the reconstruction are correct but redundant (multiple contigs). The majority of incorrect reconstruction cases are caused by partitions containing transcripts from multiple genes/loci.

In the two real datasets (human brain and fungal), about a third of the reconstructions were correct but redundant. For the Gencode dataset, higher splicing complexity led to more than half of the reconstruction being redundant. Runtime-wise, the reconstruction can be done in parallel for each individual gene family. On average, each gene family reconstruction takes less than a minute. We observe memory usage to be mostly due to calling GMAP at the end of the reconstruction (Table 6).

TABLE 6

| | | GENCODE | Human Brain | Fungal |
|---|---|---|---|---|
| Runtime (sec) | Min | 34 | 37 | 35 |
| | Max | 2368 | 97 | 90 |
| | Avg | 47 | 48 | 43 |
| | Total | 799,578 | 102,018 | 207,680 |

| | | | |
|---|---|---|---|
| Memory (GB) | 17 | 17 | 4 |

In Table 6, reconstruction for each gene family partition was run in parallel. The min, max, avg, and total runtime for each partition reconstruction is shown.

Correct and precise reconstruction is possible for large and complex genes (FIGS. 9A and 9B). These cases demonstrate the utility of Cogent in identifying isoforms from the same gene and visualizing their differences. On the other hand, reconstruction can be limited even when there are only a handful of isoforms, if these isoforms have alternative 3′ ends and no connectivity information (FIG. 9C and FIGS. 10A and 10B).

Closer inspection of the incorrect reconstructions shows that it is largely a result of having highly identical genes from separate loci. Table 7 shows that partitions that contain multiple loci are responsible for almost all of the incorrect cases. The incorrect reconstructed contigs are mostly chimeric versions of the input loci due to the high similarity between the homologous genes. Improving reconstruction of these incorrect cases, then, may require a finer partitioning step or a post-reconstruction analysis process that identifies potentially faulty reconstructions.

TABLE 7

| Partitions with: | GENCODE | Human Brain | Fungal |
|---|---|---|---|
| Mixed genes | 464/672 | 25/47 | 62/77 |
| | (70%) | (53%) | (81%) |
| Single gene | 14981/14988 | 2016/2017 | 4598/4599 |
| | (~100%) | (~100%) | (~100%) |

As shown in Table 7, partitions containing mixed genes (transcripts from multiple loci) are responsible for almost all of the incorrect reconstructions.

### 4. Discussion

In this disclosure, we describe Cogent, a tool for genome reconstruction of the transcribed regions using full-length transcript sequences without using a reference genome. We show that k-mer similarity can be used to discover gene families. We provide a graph reduction procedure that preserves the exon order information from the isoforms and outputs a minimal set of contigs that can be used to map the isoforms. Applying Cogent to two real full-length transcriptome datasets, we showed that our gene family algorithm worked extremely well and efficiently reconstructed contigs.

### REFERENCES

Angelini, Claudia, Daniela Canditiis, and Italia Feis. 2014. “Computational Approaches for Isoform Detection and Estimation: Good and Bad News.” BMC Bioinformatics 15 (1): 135-43. doi:10.1186/1471-2105-15-135.

Au, Kin Fai, and Vittorio Sebastiano. 2014. “ScienceDirect the Transcriptome of Human Pluripotent Stem Cells.” Current Opinion in Genetics & Develop-ment 28 (October). Elsevier Ltd: 71-77. doi:10.1016/j.gde.2014.09.012.

Chang, Zheng, Zhenjia Wang, and Guojun Li. 2014. “The Impacts of Read Length and Transcriptome Complexity for De Novo Assembly: a Simulation Study.” Edited by F Nina Papavasiliou. PLoS ONE 9 (4): e94825-28. doi:10.1371/journal.pone.0094825.

Chin, Chen-Shan, David H Alexander, Patrick Marks, Aaron A Klammer, James Drake, Cheryl Heiner, Alicia Clum, et al. 2013. “Nonhybrid, Finished Mi-crobial Genome Assemblies From Long-Read SMRT Sequencing Data.” Nature Methods 10 (6): 563-69. doi:10.1038/nmeth.2474.

Fu, L, B Niu, Z Zhu, S Wu, and W Li. 2012. “CD-HIT: Accelerated for Clustering the Next-Generation Sequencing Data.” Bioinformatics 28 (23). Oxford University Press: 3150-52. doi:10.1093/bioinformatics/bts565.

Gordon, Sean P, Elizabeth Tseng, Asaf Salamov, Jiwei Zhang, Xiandong Meng, Zhiying Zhao, Dongwan Kang, et al. 2015. “Widespread Polycistronic Transcripts in Fungi Revealed by Single-Molecule mRNA Sequencing.” Edited by Deyou Zheng. PLoS ONE 10 (7). Public Library of Science: e0132628. doi:10.1371/journal.pone.0132628.

Grabherr, Manfred G, Brian J Haas, Moran Yassour, Joshua Z Levin, Dawn A Thompson, Ido Amit, Xian Adiconis, et al. 2011. “Full-Length Transcrip-tome Assembly From RNA-Seq Data Without a Reference Genome.” Na-ture Biotechnology 29 (7): 644-52. doi:10.1038/nbt.1883.

Heber, S, M Alekseyev, S H Sze, H Tang, and P A Pevzner. 2002. “Splicing Graphs and EST Assembly Problem.” Bioinformatics 18 (Suppl 1). Oxford University Press: S181-88. doi:10.1093/bioinformatics/18.suppl_1.S181.

Kohler, Annegret, Alan Kuo, Laszlo G Nagy, Emmanuelle Morin, Kerrie W Barry, Francois Buscot, Björn Canbäck, et al. 2015. “Convergent Losses of Decay Mechanisms and Rapid Turnover of Symbiosis Genes in Mycorrhizal Mutualists.” Nature Genetics 47 (4): 410-15. doi:10.1038/ng.3223.

Minoche, André E, Juliane C Dohm, Jessica Schneider, Daniela Holtgräwe, Prisca Viehöver, Magda Montfort, Thomas Rosleff Sörensen, Bernd Weisshaar, and Heinz Himmelbauer. 2015. “Exploiting Single-Molecule Transcript Sequencing for Eukaryotic Gene Prediction.” Genome Biology 16 (1). Bi-oMed Central: 1. doi:10.1186/s13059-015-0729-7.

Mitchell, Stuart, Anita Kean, Andrew Mason, Michael OSullivan, and Antony Phillips. n.d. “PuLP: Python LP Solver.” https://pypi.python.org/pypi/PuLP.

Ondov, Brian D, Todd J Treangen, Adam B Mallonee, Nicholas H Bergman, Sergey Koren, and Adam M Phillippy. 2015. “Fast Genome and Meta-genome Distance Estimation Using MinHash.” bioRxiv, October. Cold Spring Harbor Labs Journals, 029827. doi:10.1101/029827.

PacificBiosciences. 2014. “Data Release: Whole Human Transcriptome From Brain, Heart, and Liver-Pacific Biosciences,” October. http://www.pacb.com/blog/data-release-whole-human-transcriptome/.

Pretto, Dalyir I, John S Eid, Carolyn M Yrigollen, Hiu-Tung Tang, Erick W Loomis, Chris Raske, Blythe Durbin-Johnson, Paul J Hagerman, and Flora Tassone. 2014. “Differential Increases of Specific FMR1mRNA Isoforms in Premutation Carriers.” Journal of Medical Genetics 52 (1): 42-52. doi:10.1136/jmedgenet-2014-102593.

Sharon, Donald, Hagen Tilgner, Fabian Grubert, and Michael Snyder. 2013. “A Single-Molecule Long-Read Survey of the Human Transcriptome.” Nature Biotechnology 31 (11): 1009-14. doi:10.1038/nbt.2705.

Shi, Jianbo, and J Malik. 2000. “Normalized Cuts and Image Segmentation.” IEEE Transactions on Pattern Analysis and Machine Intelligence 22 (8). IEEE: 888-905. doi:10.1109/34.868688.

Steijger, Tamara, Josep F Abril, Pär G Engström, Felix Kokocinski, Josep F Abril, Martin Akerman, Tyler Alioto, et al. 2013. “Assessment of Tran-script Reconstruction Methods for RNA-Seq.” Nature Methods 10 (12): 1177-84. doi:10.1038/nmeth.2714.

Sun, Cheng, Donald B Shepard, Rebecca A Chong, José López Arriaza, Kathryn Hall, Todd A Castoe, Cédric Feschotte, David D Pollock, and Rachel Lockridge Mueller. 2012. “LTR Retrotransposons Contribute to Genomic Gigantism in Plethodontid Salamanders.” Genome Biology and Evolution 4 (2). Oxford University Press: 168-83. doi:10.1093/gbe/evr139.

Swanson-Wagner, Ruth A, Steven R Eichten, Sunita Kumari, Peter Tiffin, Joshua C Stein, Doreen Ware, and Nathan M Springer. 2010. “Pervasive Gene Content Variation and Copy Number Variation in Maize and Its Undomes-ticated Progenitor.” Genome Research 20 (12). Cold Spring Harbor Lab: 1689-99. doi:10.1101/gr.109165.110.

Thomas, Sean, Jason G Underwood, Elizabeth Tseng, Alisha K Holloway, on behalf of the Bench To Basinet CvDC Informatics Subcommittee. 2014. “Long-Read Sequencing of Chicken Transcripts and Identification of New Transcript Isoforms.” Edited by Thomas Brand. PLoS ONE 9 (4): e94650-56. doi:10.1371/journal.pone.0094650.

Vilain, Marc, John Burger, John Aberdeen, Dennis Connolly, and Lynette Hirschman. 2005. “A Model-Theoretic Coreference Scoring Schem E,” February, 1-8.

Weirather, Jason L, Pegah Tootoonchi Afshar, Tyson A Clark, Elizabeth Tseng, Linda S Powers, Jason G Underwood, Joseph Zabner, Jonas Korlach, Wing Hung Wong, and Kin Fai Au. 2015. “Characterization of Fusion Genes and the Significantly Expressed Fusion Isoforms in Breast Cancer by Hybrid Sequencing.” Nucleic Acids Research 43 (18): e116-16. doi:10.1093/nar/gkv562.

Wu, Thomas D, and Colin K Watanabe. 2005. “GMAP: a Genomic Mapping and Alignment Program for mRNA and EST Sequences.” Bioinformatics 21 (9). Oxford University Press: 1859-75. doi:10.1093/bioinformatics/bti310.

Xue, Wei, Jiong-Tang Li, Ya-Ping Zhu, Guang-Yuan Hou, Xiang-Fei Kong, You-Yi Kuang, and Xiao-Wen Sun. 2013. “L_RNA_Scaffolder Scaffolding Genomes with Transcripts.” BMC Genomics 14 (1). BioMed Central: 604. doi:10.1186/1471-2164-14-604.

Zhao, Mengyao, Wan-Ping Lee, Erik P Garrison, and Gabor T Marth. 2013. “SSW Library: an SIMD Smith-Waterman C/C++ Library for Use in Ge-nomic Applications.” Edited by Leonardo Mariño-Ramírez. PLoS ONE 8 (12). Public Library of Science: e82138. doi:10.1371/journal.pone.0082138.

What is claimed is:

1. A method of generating a reconstructed coding genome contig for a gene family from a set of full-length transcript sequences, the method performed by at least one software component executing on at least one processor, comprising:
receiving a set of full-length transcript sequences;
partitioning the full-length transcript sequences into at least one gene family based on k-mer similarity;
reconstructing a coding genome contig for each of the at least one gene family without using a reference genome; and
outputting the reconstructed coding genome contig for each of the at least one gene family to a user.

2. The method of claim 1, wherein the partitioning comprises:
constructing an undirected weighted graph of the set of full-length transcript sequences comprising nodes and connecting edges, wherein each node in the graph represents a transcript sequence and a connecting edge between two nodes has a weight that is proportional to the number of shared unique k-mers between the two connected nodes, and
partitioning the full-length transcript sequences are into at least one gene family based on the constructed graph.

3. The method of claim 2, wherein constructing the undirected weighted graph comprises employing a locality-sensitive hashing procedure to identify sequence similarities.

4. The method of claim 3, wherein the locality-sensitive hashing procedure (i) uses a default sketch size of about 1000 and a k-mer size of about 16, and (ii) approximates sequence similarity based on the percentage of matching k-mer sketches.

5. The method of claim 2, wherein partitioning the nodes into at least one gene family based on the constructed graph comprises identifying connected nodes in the graph and then apply a normalized cut technique.

6. The method of claim 1, wherein the reconstructing step comprises:
building a directed weighted graph for the full-length transcripts of each of the at least one gene family; and
simplifying each directed weighted graph to generate a reconstructed coding genome contig for each of the at least one gene family, wherein simplifying comprises: unipath reduction, resolving simple bubbles, or both.

7. The method of claim 6, wherein the simplifying step comprises unipath reduction.

8. The method of claim 7, wherein a unipath comprises a continuous path of nodes comprising a leading node having a single outgoing edge, an ending node having a single incoming edge, and one or more intervening nodes each having exactly one incoming edge and one outgoing edge, wherein unipath reduction comprises deleting the one or more intervening nodes.

9. The method of claim 6, wherein the simplifying step comprises resolving simple bubbles.

10. The method of claim 9, wherein when the simple bubbles are caused by sequencing errors or a true SNP, the simple bubbles are resolved by merging the nodes in the simple bubble.

11. The method of claim 9, wherein when the simple bubbles are caused by exon skipping or intron retention, the simple bubbles are resolved by removing the node having the shorter sequence and retaining the node having the longer sequence.

12. The method of claim 6, wherein the simplifying step is performed multiple times.

13. The method of claim 6, wherein the directed graph is reduced to one node that represents the reconstructed coding genome contig.

14. The method of claim 1, wherein the full-length transcript sequences are produced by a single molecule long read sequencing process.

15. The method of claim 1, wherein the k-mer size is set from about 10 to 30 bases.

16. The method of claim 1, wherein the sequences have an accuracy of ≥99%.

17. The method of claim 1, wherein when a partitioned gene family of the at least one gene families is above a threshold size, the method further comprises:
(i) splitting the partitioned gene family into multiple sub-partitions;
(ii) subjecting each sub-partition to the reconstructing step;
(iii) combining the reconstructed coding genome contig for all sub-partitions to generate a combined contig; and
(iv) subjecting the combined contig to the reconstructing step.

18. The method of claim 1, wherein when the reconstructed coding genome contig cannot be resolved unambiguously and thus comprises two or more unconnected contigs, the minimal set of contigs that can fully explain the isoforms is output.

19. The method of claim 1, wherein the output comprises and displaying visualizations of each of the transcripts of the at least one gene family aligned and the reconstructed coding genome contig.

20. A system for generating a reconstructed coding genome contig for a gene family from a set of full-length transcript sequences, comprising:
a memory;
an input/output module; and
a processor coupled to the memory configured to perform the method of claim 1.
